(19) United States
(12) Patent Application Publication
(10) Pub. No.: US 2026/0237262 A1
(43) Pub. Date: Aug. 13, 2026

(54) ACCESS CONTROL LOCK ARRANGEMENT

(71) Applicant: James Gullaci, Wattle Grove (AU)

(72) Inventor: James Gullaci, Wattle Grove (AU)

(21) Appl. No.: 19/470,821

(22) PCT Filed: Mar. 30, 2024
(86) PCT No.: PCT/AU2024/050301

§ 371 Date: Sep. 30, 2025

(30) Foreign Application Priority Data
Mar. 30, 2023 (AU) 2023900899

(51) Int. Cl. G07C 9/00; G06Q 20/32; G06Q 20/34; G06Q 20/40; G07C 9/29

(52) U.S. Cl. CPC G07C 9/00896; G06Q 20/326; G06Q 20/341; G06Q 20/401; G07C 9/00944; G07C 9/29; G07C 2009/00388; G07C 2009/00769

(57) ABSTRACT

Provided is an access control lock arrangement 10 for selectively securing an accessway 6. The arrangement 10 comprises a lock mechanism 12 configured to secure an access 8 to such accessway 6, and an actuator 14 configured to actuate the lock mechanism 12. Arrangement 10 also includes a controller 16 arranged in signal communication with the actuator 14 and comprising an interrogator 18 for interrogating a smart card 20 to obtain a financial identifier therefrom, as well as a network interface 22 configured for operative interfacing with a financial network 24 to verify said obtained 18 financial identifier as payment confirmation. In this manner, upon verification of such payment confirmation, the controller 16 is configured to control the actuator 14 to actuate the lock mechanism 12 to facilitate access control.

### TECHNICAL FIELD

This invention relates broadly to the field of access control, and more specifically to an access control lock arrangement and an associated method of access control.

### BACKGROUND ART

The following discussion of the background art is intended to facilitate an understanding of the present invention only. The discussion is not an acknowledgement or admission that any of the material referred to is or was part of the common general knowledge as at the priority date of the application.

In physical security, access control is generally the selective restriction of access to a place, such as a building or space, where the act of accessing typically means entering or gaining access to such a place.

Applicant has identified a shortcoming in the art of conventional access control, such as conventional mechanical and electronic locks, which are generally binary selective, wherein access is obtainable via having a key, code or electronic key which either opens the lock or not.

For example, access control to amenities such as sporting facilities in sport complexes or centres, for example gaining access to a pool table or gym equipment in a room, conventionally requires some form of membership, such as monthly or yearly membership where an access fob or key is provided as part of such membership, or the facility requires a receptionist to provide access, or the like.

Prior art investigations have identified conventional prior art systems for access control. For example, US 2016/0300411 to Isaacson describes hotel door unlocking and more specifically to using a payment account as a key to unlock a hotel room door. Isaacson addresses the problem of needing a key card given to a customer. Having a separate key card for unlocking a hotel room door adds bulk to a wallet when stored with other plastic cards and can be uncomfortable. Sometimes, customers forget to take a key card with them when leaving a hotel room, as the key card is not attached to a key ring as a traditional key typically is. As a result, customers become locked out of their hotel rooms and must notify hotel staff to gain re-entry.

Similarly, U.S. Pat. No. 9,965,911 to Wishne describes an electronic access control system which addresses the need for expediting the process for hotel guests to check-in and also to reduce the need to carry an extra keycard. Along a similar vein, US 2022/0129894 to Phillips et al. teaches access control arrangements where an ‘on the spot’ payment is enabled to provide access control, such as at a turnstile, a revolving door, or the like. However, these prior art systems provide solutions that are generally binary selective, where a payment key or code replaces a conventional mechanical key which is used to provide access or not.

In light of these shortcomings, Applicant has identified a need for an improved access control methodology which is not binary selective and the current invention was conceived with this goal in mind.

### SUMMARY OF THE INVENTION

The skilled addressee is to appreciate that reference herein to a ‘smart card’ (also known as a chip card, or integrated circuit card (ICC or IC card) generally comprises broad and non-exclusive reference to a physical electronic authentication device, used to control access to a resource. A typical embodiment of such a smart card comprises a plastic credit card-sized card with an embedded integrated circuit (IC) chip, but variations hereon are possible and such smart card may comprise any suitable automatic identification and data capture (AIDC) means. Such AIDC means generally refers to any suitable technique of methodology for automatically and without user data entry, identifying an object and entering relevant data directly into a computer system (i.e. without human involvement). Examples of AIDC technologies include bar codes, Quick Response (QR) tags, Radio Frequency Identification (RFID), Near-Field Communication (NFC), data tags, magnetic stripes, smart cards, etc. For example, a mobile phone with a suitable banking app coupled with an NFC device would comprise such a ‘smart card’ in this specification.

In addition, the skilled addressee is to appreciate that reference herein to ‘accessway’ generally comprises broad reference to any suitable path or route whereby access is gainable to a space or room, such as a doorway, with similar reference to an ‘access’ comprising broad reference to any movable impediment or barries regulating access to such an accessway, such as a gate, a door, etc.

According to a first aspect of the invention there is provided an access control lock arrangement for selectively securing an accessway, said arrangement comprising:
a lock mechanism comprising a mechanical lock with a bolt configured to secure an access to such accessway;
an actuator configured to actuate said lock mechanism by displacing said bolt; and
a controller arranged in signal communication with the actuator and comprising:
   i. an interrogator for interrogating a smart card to obtain a financial identifier therefrom;
   ii. a network interface configured for operative interfacing with a financial network to verify said obtained financial identifier as payment confirmation; and
   iii. a timer via which a duration of access control is able to be facilitated;
      wherein upon verification of such payment confirmation the controller is configured commence the timer and release the lock via the actuator, with a subsequent obtainment of the same financial identifier stopping the timer and securing the lock mechanism, a quantum of said payment confirmation determined by such a timed duration, thereby facilitating temporal selective access control.

In an embodiment, the arrangement is comprised in a unitary manner as a door lock with handle.

In an embodiment, the lock mechanism comprises an electromagnetic lock actuatable by means of the actuator.

In an embodiment, the actuator comprises an electromechanical actuator, such as a linear actuator, configured to actuate the lock mechanism.

In an embodiment, the actuator comprises an electrical circuit, such as a solenoid, configured to actuate the lock mechanism.

In an embodiment, the lock mechanism comprises a physical bypass for bypassing the lock mechanism and release the access to the accessway, such as a key.

In an embodiment, the controller comprises any suitable processor or microcontroller configured to receive input, perform logical and arithmetical operations on a suitable instruction set, and provide output, as well as transitory and/or non-transitory electronic storage.

In an embodiment, the controller comprises a display configured to display information, such as a cost of access control.

In an embodiment, the controller comprises a user input configured to receive user input.

In an embodiment, the user input comprises a button which, when activated, causes the controller to display a cost of access control on the display.

In an embodiment, the display comprises a user input by means of a touchscreen whereby a user is able to provide user input.

In an embodiment, the interrogator is selectable from a non-exhaustive group consisting of an optical bar code reader, a Quick Response (QR) reader, a Radio Frequency Identification (RFID) reader, a Near-Field Communication (NFC) reader, and a magnetic strip reader.

Typically, the financial identifier comprises an electronic identifier able to uniquely identify a payment method of a user, e.g. credit card details, digital wallet details, etc.

In an embodiment, the network interface comprises a wired and/or wireless interface.

In an embodiment, the network interface is configured to communicate via a network protocol selectable from a non-exclusive group consisting of an IEEE 802.11 (Wi-Fi™) and an IEEE 802.15 (Bluetooth™) family of communication protocols, including a Wireless Application Protocol (WAP).

In an embodiment, the network interface is configured to interface with a financial network via a distributed network, such as the Internet.

In an embodiment, the controller is configured to verify the obtained financial identifier as payment confirmation by verifying that a financial account identified by the financial identifier includes sufficient funds for access control.

In an embodiment, the timed duration comprises an amount of time between the obtained financial identifier and the subsequent obtainment of the same financial identifier, i.e. from when the timer is commenced and until when said timer is stopped.

In an embodiment, the controller is configured to interface with a software application or ‘app’ via the network interface, said app configured to provide user input, such as the predetermined amount of time for access control.

In an embodiment, the controller is configured to interface with a software application or ‘app’ via the network interface, said app configured with a virtual bypass for bypassing the lock mechanism to release the access to the accessway.

According to a second aspect of the invention there is provided a method of access control for selectively securing an accessway, said method comprising the steps of:
by means of a controllable lock mechanism, securing an access to such accessway;
by means of an interrogator, interrogating a smart card to obtain a financial identifier therefrom;
by means of a network interface, interfacing with a financial network to verify said obtained financial identifier as payment confirmation;
upon verification of such payment confirmation, by means of a controller having a timer and configured to control an actuator, commencing the timer and releasing the lock via the actuator; and
upon interrogating the smart card again to obtain the financial identifier therefrom, by means of the controller, stopping the timer and securing the lock mechanism, a quantum of the payment confirmation determined by a duration between obtaining the financial identifier to facilitate temporal selective access control.

In an embodiment, the method includes the step of displaying, via the controller, information, such as a cost of access control.

In an embodiment, the method comprises the step of receiving, via a user input, user input.

In an embodiment, the step of receiving user input comprises receiving a predetermined duration for which access control is to be facilitated.

In an embodiment, the step of interfacing is performed by means of a network protocol selectable from a non-exclusive group consisting of an IEEE 802.11 (Wi-Fi™) and an IEEE 802.15 (Bluetooth™) family of communication protocols, including a Wireless Application Protocol (WAP).

In an embodiment, the step of verifying the obtained financial identifier as payment confirmation comprises verifying that a financial account identified by the financial identifier includes sufficient funds for access control.

According to a third aspect of the invention there is provided a method of access control for selectively securing an accessway, said method comprising use of the access control lock arrangement in accordance with the first aspect of the invention.

According to a further aspect of the invention there is provided an access control lock arrangement and a method of access control, substantially as herein described and/or illustrated.

### BRIEF DESCRIPTION OF THE DRAWINGS

The description will be made with reference to the accompanying drawings in which:

FIG. 1 is a diagrammatic perspective-view representation of one embodiment of an access control lock arrangement, in accordance with aspects of the present invention;

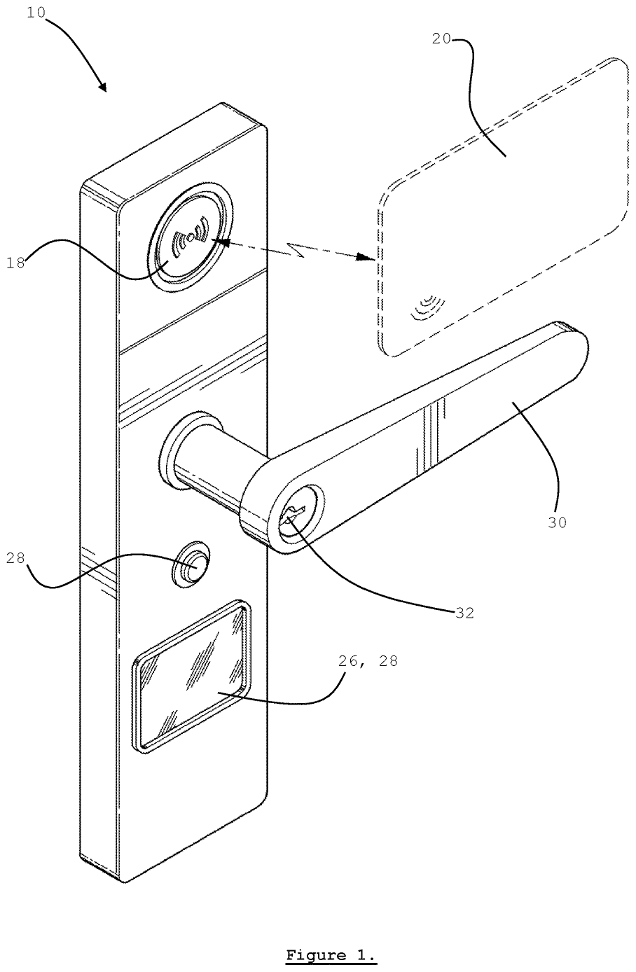

FIG. 2 is a diagrammatic front-view representation of the access control lock arrangement of FIG. 1, used to secure an access to an accessway; and

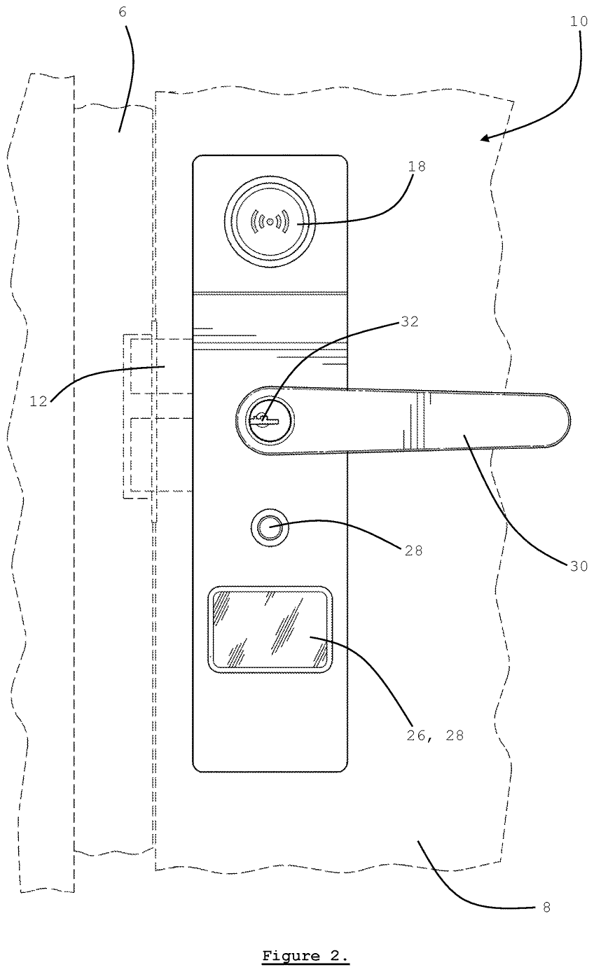

FIG. 3 is diagrammatic internal-view representation of the access control lock arrangement of FIG. 1, showing internal components and schematic interfacing with a financial network.

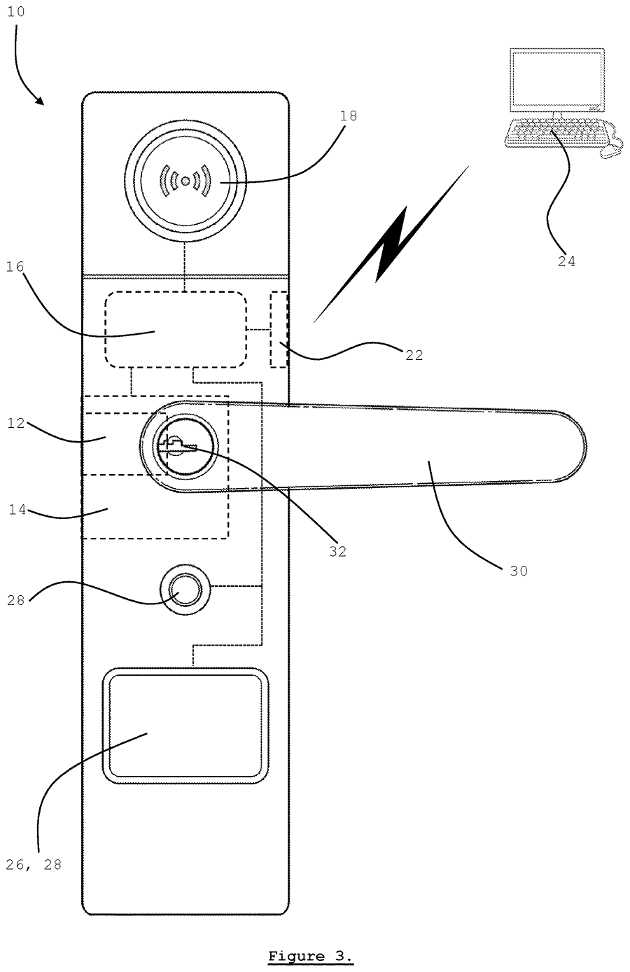

### DETAILED DESCRIPTION OF EMBODIMENTS

Further features of the present invention are more fully described in the following description of several non-limiting embodiments thereof. This description is included solely for the purposes of exemplifying the present invention to the skilled addressee. It should not be understood as a restriction on the broad summary, disclosure or description of the invention as set out above.

In the figures, incorporated to illustrate features of the example embodiment or embodiments, like reference numerals are used to identify like parts throughout. Additionally, features, mechanisms and aspects well-known and understood in the art will not be described in detail, as such features, mechanisms and aspects will be within the understanding of the skilled addressee.

Additionally, the accompanying figures do not represent engineering or design drawings, but provide a functional overview of the invention only. As a result, features and practical construction details required for various embodiments may not be indicated in each figure, but such construction requirements will be within the understanding of the skilled addressee.

Broadly, the present invention provides for an access control lock arrangement 10 which finds particular application in selectively securing an accessway 6 with a suitable access 8, for example securing a doorway 6 with door or gate 8. Arrangement 10 generally comprises a lock mechanism 12, an actuator 14 and a controller 16 having an interrogator 18 and network interface 22. Lock arrangement 10 also typically comprises a suitable energy supply, such as an electrical energy supply to energise suitable constituent parts thereof, such as controller 16 and actuator 24. For example, lock arrangement 10 may comprise a battery and backup mains electrical supply (not shown), or the like.

As will be described in more detail below, lock arrangement 10 is configured to facilitate access control via interrogation of a smart card 20 which, as described above, may comprise reference to any suitable physical electronic authentication device, such as a credit card-style IC card, a mobile phone with NFC capabilities, and/or the like, as generally understood in the art.

With reference now to the accompanying figures, there is exemplified one possible embodiment of such an access control lock arrangement 10 for selectively securing an accessway 6. The skilled addressee is to appreciate that, in a preferred embodiment, the arrangement 10 is generally comprised in a unitary manner as a single door lock with handle 30 unit, as shown. However, variations hereon are possible and expected.

Arrangement 10 typically comprises a lock mechanism 12 which is configured to secure an access 6, such as a door or gate, to an accessway 6, such as a doorway. Also included is an actuator 14 which is configured to actuate said lock mechanism 12.

In one embodiment, the lock mechanism 12 comprises a mechanical lock with a bolt displaceable by means of the actuator 14. In such an embodiment, the actuator 14 typically comprises an electromechanical actuator, such as a linear actuator, which is configured to actuate the lock mechanism. In another embodiment, the lock mechanism 12 may comprises an electromagnetic lock actuatable by means of the actuator 14. In such an embodiment, the actuator 14 typically comprises an electrical circuit, such as a solenoid or the like, which is configured to actuate the lock mechanism, e.g. control an electricity supply to the electromagnetic lock. In a typical embodiment, the lock mechanism 12 generally comprises a physical bypass for bypassing the lock mechanism 12 and release the access to the accessway, such as a key, or the like. To this end, lock mechanism 12 includes a keyway or key slot 32 for accepting a key as physical bypass.

Arrangement 10 also includes a controller 16 which is arranged in signal communication with the actuator 14. The controller 16 generally comprises any suitable processor or microcontroller which is configured to receive input, perform logical and arithmetical operations on a suitable instruction set, and provide output, as well as transitory and/or non-transitory electronic storage, as generally understood in the art.

The controller 16 comprises an interrogator 18 for interrogating a smart card 20 to obtain a financial identifier therefrom. In one embodiment, the interrogator 18 is selectable from a non-exhaustive group consisting of an optical bar code reader, a Quick Response (QR) reader, a Radio Frequency Identification (RFID) reader, a Near-Field Communication (NFC) reader, and a magnetic strip reader. Typically, the financial identifier comprises an electronic identifier able to uniquely identify a payment method of a user, e. g. credit card details, digital wallet details, etc., as known in the art of electronic payment systems.

The controller 16 also includes a network interface 22 which is configured for operative interfacing with a financial network (diagrammatically represented by remote computer system 24) to verify said obtained financial identifier as payment confirmation. For example, the financial network 24 may comprise a banking or similar financial institution network, or the like. In one embodiment, the network interface 22 may comprise a wired and/or wireless interface. In one embodiment, the network interface 22 is configured to communicate via a network protocol selectable from a non-exclusive group consisting of an IEEE 802.11 (Wi-Fi™) and an IEEE 802.15 (Bluetooth™) family of communication protocols, including a Wireless Application Protocol (WAP). In one embodiment, the network interface 22 is configured to interface with a financial network 24 via a distributed network, such as the Internet. Of course, variations on communications protocols and implementations are possible and expected.

In one embodiment, the controller 16 is generally configured to verify the obtained financial identifier as payment confirmation by verifying that a financial account identified by the financial identifier includes sufficient funds for access control, i.e. a user using the smart card 20 has sufficient funds to purchase access control. In the manner thus described, upon verification of such payment confirmation, the controller 16 is configured to control the actuator 14 to actuate the lock mechanism 12 in order to facilitate access control, i.e. unlock the lock mechanism 12 to allow access to the accessway 6.

Various optional embodiments are possible and within the scope of the present invention. For example, in one embodiment, the controller 16 comprises a display 26 which is configured to display information, such as a cost of access control. In one embodiment, the controller 16 also comprises a user input 28 which is configured to receive user input. For example, in one embodiment, the user input 28 comprises a button which, when activated or pressed, causes the controller 16 to display a cost of access control on the display 26. In one embodiment, the display 26 may comprise the user input 28 by means of a touchscreen, whereby a user is able to provide such user input, or the like.

Additionally, in a preferred embodiment, the controller 16 comprises a timer via which a predetermined duration of access control is able to be facilitated, e.g. payment confirmation allows one hour of access control, or the like. Such a timer may be implemented via suitable programming, or the like. In one embodiment, the predetermined amount of time is selectable via the user input 28, i.e. a user selects how long to purchase access control. In one embodiment, the controller 16 is configured to commence a timer to release the lock mechanism 12 upon obtainment of the financial identifier, with a subsequent obtainment of the same financial identifier stopping the timer and securing the lock mechanism 12, a quantum of said payment confirmation determined by such a timed duration. For example, a person may scan their smart card 20 to commence the timer and open the lock, with the lock arrangement 10 requiring a second scan of the same card 20 to stop the timer, with an amount payable for the time the lock was unlocked determined by such a duration between first and second scans of the smart card 20.

In this manner, the present invention is able to provide temporal selective access control, where an amount of time of access is purchased, or timed for purchase, rather than simply binary selective access control, where having a key, physical or electronic, provides access.

In one embodiment, the controller 16 may also be configured to interface with a software application or ‘app’ via the network interface 22. Such an app may be configured to provide user input, such as the predetermined amount of time for access control, or the like. Similarly, in one embodiment, the controller 16 may be configured to interface with a software application or ‘app’ via the network interface 22, said app configured with a virtual bypass for bypassing the lock mechanism 12 to release the access 8 to the accessway 6. In such a manner, a suitable app may be realised whereby users of the lock arrangement 10 are able to select and pay for access control, as well as allow an owner of the accessway to remotely control access, as required.

The skilled addressee is to appreciate that the present invention includes an associated method of access control for selectively securing an accessway 6, typically using an embodiment of the lock arrangement 10. Such a method broadly comprises the steps of by means of the controllable lock mechanism 12, securing the access 8 to the accessway 6; by means of the interrogator 18, interrogating a smart card 20 to obtain a financial identifier therefrom; by means of the network interface 22, interfacing with a financial network 24 to verify said obtained financial identifier as payment confirmation; and upon verification of such payment confirmation, by means of the controller 16 configured to control the actuator 14, actuating said lock mechanism 12 to facilitate access control.

In the manner described herein, lock arrangement 10 enables selective access to, for example, sporting activities in sports complexes, e.g. gaining access to a pool table room or exercise equipment, without the need for a periodic subscription or membership, or a receptionist to provide keys, etc. Similarly, using the lock arrangement 10 on an access to, for example, a room within a property for rent, facilitates payment of access to the room only as a person needs it, or the like.

Applicant believes it particularly advantageous that the present invention provides for a lock arrangement 10 and associated method whereby access control may be facilitated on demand once a smart card 20 with associated payment verification is provided. Similarly, arrangement 10 allows for timing of access control with associated payment determinable depending on duration of access wanted. As a result, the present invention provides for a lock arrangement 10 which is not merely binary selective, but rather temporal selective, where access is granted for a predetermined period of time according to a payment provided. Such a solution finds particular application with, for example, sporting facilities in sport complexes or centres, for example gaining access to a pool table or gym equipment in a room, or places that conventionally require some form of membership where an access fob or key is provided, or the like.

Optional embodiments of the present invention may also be said to broadly consist in the parts, elements and features referred to or indicated herein, individually or collectively, in any or all combinations of two or more of the parts, elements or features, and wherein specific integers are mentioned herein which have known equivalents in the art to which the invention relates, such known equivalents are deemed to be incorporated herein as if individually set forth. In the example embodiments, well-known processes, well-known device structures, and well-known technologies are not described in detail, as such will be readily understood by the skilled addressee.

The use of the terms “a”, “an”, “said”, “the”, and/or similar referents in the context of describing various embodiments (especially in the context of the claimed subject matter) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. As used herein, the term “and/or” includes any and all combinations of one or more of the associated listed items. No language in the specification should be construed as indicating any non-claimed subject matter as essential to the practice of the claimed subject matter.

It is to be appreciated that reference to “one example” or “an example” of the invention, or similar exemplary language (e.g., “such as”) herein, is not made in an exclusive sense. Various substantially and specifically practical and useful exemplary embodiments of the claimed subject matter are described herein, textually and/or graphically, for carrying out the claimed subject matter. These examples are intended to assist the skilled person in performing the invention and are not intended to limit the overall scope of the invention in any way unless the context clearly indicates otherwise. The inventor(s) expects skilled artisans to employ variations as appropriate, and the inventor(s) intends for the claimed subject matter to be practiced other than as specifically described herein.

Any method steps, processes, and operations described herein are not to be construed as necessarily requiring their performance in the particular order discussed or illustrated, unless specifically identified as an order of performance. It is also to be understood that additional or alternative steps may be employed.

1. An access control lock arrangement for selectively securing an accessway, said arrangement comprising:
a lock mechanism comprising a mechanical lock with a bolt configured to secure an access to such accessway;
an actuator configured to actuate said lock mechanism by displacing said bolt; and
a controller arranged in signal communication with the actuator and comprising:
i. an interrogator for interrogating a smart card to obtain a financial identifier therefrom;
ii. a network interface configured for operative interfacing with a financial network to verify said obtained financial identifier as payment confirmation; and
iii. a timer via which a duration of access control is able to be facilitated;
wherein upon verification of such payment confirmation the controller is configured commence the timer and release the lock via the actuator, with a subsequent obtainment of the same financial identifier stopping the timer and securing the lock mechanism, a quantum of said payment confirmation determined by such a timed duration, thereby facilitating temporal selective access control.

2. The access control lock arrangement of claim 1, which is comprised in a unitary manner as a door lock with handle.

3. The access control lock arrangement of claim 1, wherein the lock mechanism comprises an electromagnetic lock actuatable by means of the actuator.

4. The access control lock arrangement of claim 1, wherein the actuator comprises an electromechanical actuator, such as a linear actuator, configured to actuate the lock mechanism.

5. The access control lock arrangement of claim 1, wherein the actuator comprises an electrical circuit, such as a solenoid, configured to actuate the lock mechanism.

6. The access control lock arrangement of claim 1, wherein the lock mechanism comprises a physical bypass for bypassing the lock mechanism and release the access to the accessway, such as a key.

7. The access control lock arrangement of claim 1, wherein the controller comprises a display configured to display information, such as a cost of access control.

8. The access control lock arrangement of claim 1, wherein the controller comprises a user input configured to receive user input.

9. The access control lock arrangement of claim 8, wherein the user input comprises a button which, when activated, causes the controller to display a cost of access control on a display.

10. The access control lock arrangement of claim 7, wherein the display comprises a user input by means of a touchscreen whereby a user is able to provide user input.

11. The access control lock arrangement of claim 1, wherein the interrogator is selectable from a non-exhaustive group consisting of an optical bar code reader, a Quick Response (QR) reader, a Radio Frequency Identification (RFID) reader, a Near-Field Communication (NFC) reader, and a magnetic strip reader.

12. The access control lock arrangement of claim 1, wherein the financial identifier comprises an electronic identifier able to uniquely identify a payment method of a user, such as credit card details, digital wallet details, or the like.

13. The access control lock arrangement of claim 1, wherein the network interface comprises a wired and/or wireless interface and is configured to interface with a financial network via a distributed network, such as the Internet.

14. The access control lock arrangement of claim 1, wherein the controller is configured to verify the obtained financial identifier as payment confirmation by verifying that a financial account identified by the financial identifier includes sufficient funds for access control.

15. The access control lock arrangement of claim 1, wherein the controller is configured to interface with a software application or ‘app’ via the network interface, said app configured to provide user input, such as the predetermined amount of time for access control.

16. The access control lock arrangement of claim 1, wherein the controller is configured to interface with a software application or ‘app’ via the network interface, said app configured with a virtual bypass for bypassing the lock mechanism to release the access to the accessway.

17. A method of access control for selectively securing an accessway, said method comprising the steps of:
by means of a controllable lock mechanism, securing an access to such accessway;
by means of an interrogator, interrogating a smart card to obtain a financial identifier therefrom;
by means of a network interface, interfacing with a financial network to verify said obtained financial identifier as payment confirmation;
upon verification of such payment confirmation, by means of a controller having a timer and configured to control an actuator, commencing the timer and releasing the lock via the actuator; and
upon interrogating the smart card again to obtain the financial identifier therefrom, by means of the controller, stopping the timer and securing the lock mechanism, a quantum of the payment confirmation determined by a duration between obtaining the financial identifier to facilitate temporal selective access control.

18. The method of claim 17, which includes the step of displaying, via the controller, information, such as a cost of access control.

19. The method of claim 17, which comprises the step of receiving, via a user input, user input which comprises receiving a predetermined duration for which access control is to be facilitated.

20. The method of claim 17, wherein the step of verifying the obtained financial identifier as payment confirmation comprises verifying that a financial account identified by the financial identifier includes sufficient funds for access control.

21. (canceled)
